(19) United States
(12) Patent Application Publication
(10) Pub. No.: US 2026/0086530 A1
(43) Pub. Date: Mar. 26, 2026

(54) WEARABLE ELECTRONIC DEVICE FOR COOPERATION WITH OTHER DEVICE FOR MANAGING HEALTH USING ARTIFICIAL INTELLIHENCE MODEL, AND OPERATION METHOD OF THE SAME

(71) Applicant: UUUUU INC, Seoul (KR)

(72) Inventor: Minsuh KIM, Seoul (KR)

(21) Appl. No.: 19/343,826

(22) Filed: Sep. 29, 2025

Related U.S. Application Data
(63) Continuation of application No. PCT/KR2024/003824, filed on Mar. 27, 2024.

(30) Foreign Application Priority Data
Mar. 27, 2023 (KR) 10-2023-0039509
Nov. 20, 2023 (KR) 10-2023-0160710

(51) Int. Cl. G05B 19/4099; G06T 7/13; G06T 7/33; G06T 7/73; G06T 7/90; G06T 11/00; G06V 10/25; G06V 10/26

(52) U.S. Cl. CPC G05B 19/4099; G06T 7/13; G06T 7/337; G06T 7/74; G06T 7/90; G06T 11/10; G06V 10/25; G06V 10/26; G05B 2219/49023; G06T 2207/10024; G06T 2207/20164

(57) ABSTRACT

An operation method of a server. The operation method includes: obtaining a nail image; generating a mask image including a first region of interest corresponding to the first nail area; generating a plurality of first points for the first region of interest; generating a plurality of second points for a second region of interest of a template image corresponding to the nail image; obtaining a transformation function based on a result of a comparison between coordinate values of the plurality of first points and coordinate values of the plurality of second points; obtaining a modified image including a modified nail area based on the transformation function and a color value of the first nail area; and obtaining a printing file based on the modified image and controlling a production facility performing 3D printing based on the printing file to generate a gel nail.

### CROSS-REFERENCE TO RELATED APPLICATIONS

This application is a continuation application of the International Patent Application No. PCT/KR2024/003824, filed on Mar. 27, 2024, which claims priority from Korean Patent Application No. 10-2023-0039509, filed on Mar. 27, 2023 and Korean Patent Application No. 10-2023-0160710, filed on Nov. 20, 2023, the entire contents of which are hereby incorporated by reference.

### BACKGROUND

### 1. Field

Various embodiments of the present invention relate to an electronic device for 3D printing of a gel-nail product based on an actual nail image, and a method of operating the same.

### 2. Description of Related Art

As one of the means of expressing the human pursuit of physical beauty, the beauty industry has been accelerating in development while simultaneously becoming more specialized. In particular, since the 20th century, with the rapid expansion of the market, the beauty industry has begun to be popularized among the general public. Among the beauty sectors, nail art has recently achieved rapid progress as an essential form of body art regardless of age or gender.

Originally, nail art, as a field of beauty art, has been one of the ways to decorate the human body beautifully, wherein the length, shape, or color of artificial nails has been expressed to reflect changes and values of the contemporary culture.

In general, nail art has been carried out by applying pigments such as nail polish of various colors onto fingernails and toenails. However, such methods of applying liquid pigments require long curing times after application, causing inconvenience to the user.

Furthermore, nail art is not easy to draw by oneself, and in most cases, individuals spend high costs to receive services from professionals. Nevertheless, due to frequent hand washing, various shapes or characters printed on the nails often fade away within only a few days, thereby raising the issue that the effect is insignificant compared to the high expense.

Meanwhile, in order to overcome such problems, nail-art stickers have been used by attaching them to nails. However, most of these are simple planar configurations and are manufactured merely by forming a printed layer, failing to provide aesthetic beauty. Thus, conventional stickers are insufficient to satisfy the diverse preferences of consumers. Moreover, in cases where coatings and white layers are applied over an adhesive for printing, multiple processes must be performed depending on the pattern colors, resulting in complicated and cumbersome printing processes and increased product costs.

As another type of nail art, dry nail stickers were developed to overcome the problems of liquid application such as nail polish or UV gel. However, these are mostly films composed of the same raw materials as nail polish, which must be cut and trimmed to match the size of the nail after attachment, thereby causing inconvenience. Even if they are neatly applied, users suffer from significant discomfort due to the hard and heavy foreign sensation.

In addition, when nails are short, artificial nails are used for extension. However, such artificial nails have poor fit and adhesion, and do not naturally settle on the nail, resulting in reduced aesthetics, and sometimes the artificial nail falls off entirely from the natural nail. Furthermore, after extending nails with artificial nails, nail art must again be applied, which is cumbersome and difficult, thereby requiring professional assistance, resulting in significant cost and time burdens. Moreover, when such extended artificial nails are removed, severe damage occurs to the natural nails, and gaps between natural and artificial nails often cause hair entanglement, unnatural appearance, hygiene problems, and short durability.

Accordingly, the inventors continued research to develop a gel-nail sticker for nail extension, which enables the natural extension of nails simply and conveniently without the need for artificial nail tips, thereby preventing damage to the natural nails while ensuring long-term durability. As a result, they discovered that by using a gel-nail sticker including a gel layer formed of a specific ratio of UV-curable resin and thermosetting resin, the nails can be naturally extended without artificial nail extensions, and nail art can be conveniently applied. Thus, the present invention has been completed.

### SUMMARY

Conventional systems for producing nail products, e.g., gel-nail stickers, have adopted a method of mass-producing a small variety of low-quality gel-nail stickers using large-scale production facilities. Accordingly, it has been difficult to satisfy the needs of consumers who desire ever-changing and high-quality nail products.

According to various embodiments, the electronic device and its operating method can enhance consumer satisfaction by producing high-quality gel-nail stickers in a wide variety of designs, customized for individual consumers, using 3D printing technology.

According to other embodiments, the electronic device and its operating method may perform an operation of transforming a nail image into a 3D-printable form based on a transformation function calculated from feature information of a real nail photograph, nail image of an artist's nail product, thereby enabling efficient production of various nail product designs through 3D printing.

According to still other embodiments, the electronic device and its operating method may convert the deformed image into various types of vector images based on segmentation algorithms and generative AI, thereby allowing gel-nail designers to conveniently generate printing files based on the vector images for efficiently printing nail products.

According to various embodiments, in a method of operating a server, the method may include: obtaining a nail image including a first nail region corresponding to a nail product worn on a nail; generating a mask image including a first region of interest corresponding to the first nail region; and generating a plurality of first points for the first region of interest. Distances between the plurality of first points are determined based on a predefined nail curvature. The method further includes generating a plurality of second points for a second region of interest of a template image corresponding to the nail image; obtaining a transformation function based on a comparison result of coordinate values of the plurality of first points and the plurality of second points; obtaining a deformed image including a transformed nail region based on the transformation function and color values of the first nail region; and obtaining a printing file based on the deformed image, and controlling a production facility to generate a gel-nail product by performing 3D printing based on the printing file.

According to other embodiments, in a method of operating a server, the method may include: obtaining a nail image, wherein the nail image includes a first nail region corresponding to a nail product and a first background region; identifying a plurality of first sub-regions within the nail region; generating a pattern image based on identifying representative colors corresponding to the plurality of first sub-regions. The pattern image includes a second nail region comprising the plurality of first sub-regions with the representative colors assigned, and a second background region. The method further includes generating a plurality of reference images based on the pattern image, wherein each of the plurality of reference images includes an image region corresponding to the second nail region and a remaining region including a design generated based on the second nail region; identifying a plurality of second sub-regions within a specific image among the plurality of reference images; generating a plurality of vector images corresponding to the plurality of second sub-regions; generating a printing file based on at least some of the plurality of vector images; and controlling a production facility to generate a gel-nail product by performing 3D printing based on the printing file.

According to various embodiments, an electronic device and a method of operating the same are provided, which improve consumer satisfaction by producing high-quality gel-nail stickers in a wide variety of designs, customized for individual consumers, using a 3D printing method.

According to other embodiments, an electronic device and a method of operating the same are provided, which enable efficient production of diverse nail product designs by performing an operation of transforming a nail image into a 3D-printable form based on a transformation function calculated from feature information of a nail image of an artist's nail product.

According to still other embodiments, an electronic device and a method of operating the same are provided, which allow gel-nail designers to conveniently generate printing files for efficiently printing nail products by converting deformed images into various types of vector images based on segmentation algorithms and generative AI transformation functions.

### BRIEF DESCRIPTION OF THE DRAWINGS

FIG. 1 is a block diagram of a nail 3D printing system according to various embodiments.

FIG. 2 is a diagram for explaining an electronic device using the nail 3D printing system according to various embodiments.

FIG. 3 is a block diagram illustrating an example of components of a server and a production facility according to various embodiments.

FIG. 4 is a diagram illustrating an example of an operation of generating a printing file by the server according to various embodiments.

FIGS. 5A, 5B and 5C are diagrams illustrating examples of a nail image, a template image, and a deformed image according to various embodiments.

FIG. 6 is a block diagram illustrating components of an electronic device according to various embodiments.

FIG. 7 is a flowchart illustrating an example of an operation of generating a nail product by the server according to various embodiments.

FIG. 8 is a flowchart illustrating an example of an operation of transforming a nail image based on a transformation function by the server according to various embodiments.

FIG. 9 is a diagram illustrating an example of an operation of transforming a nail image by the server according to various embodiments.

FIG. 10 is a flowchart illustrating an example of an operation of generating a gel nail based on the transformation of a nail image by the server according to various embodiments.

FIG. 11 is a diagram illustrating an example of operations of modules for obtaining a deformed image according to various embodiments.

FIG. 12 is a diagram illustrating an example of an operation of generating a deformed image according to various embodiments.

FIGS. 13A, 13B, 14A and 14B are diagrams illustrating examples of an operation of generating points for a mask image by the server according to various embodiments.

FIGS. 15A and 15B are diagrams illustrating an example of intervals between points generated on a mask image based on a predefined curvature of a nail according to various embodiments.

FIG. 16A is a diagram illustrating an example of an operation of comparing points of a mask image and points of a template image according to various embodiments.

FIG. 16B is a diagram illustrating another example of an operation of comparing points of a mask image and points of a template image according to various embodiments.

FIG. 17 is a flowchart illustrating an example of an operation of obtaining a transformed nail image based on an artificial intelligence model by the server according to various embodiments.

FIGS. 18A and 18B are diagrams illustrating an example of an artificial intelligence model according to various embodiments.

FIG. 19 is a flowchart illustrating an example of an operation of generating a printing file based on a deformed image according to various embodiments.

FIG. 20 is a diagram illustrating an example of an operation of obtaining information for respective sub-regions of a deformed image according to various embodiments.

FIG. 21 is a diagram illustrating an example of an operation of generating a first pattern image based on information of respective sub-regions according to various embodiments.

FIG. 22 is a diagram illustrating an example of an operation of generating a plurality of second pattern images based on the first pattern image according to various embodiments.

FIG. 23 is a diagram illustrating an example of an operation of vectorizing a specific pattern image among the plurality of pattern images according to various embodiments.

FIG. 24 is a diagram illustrating an example of an operation of generating a printing file according to various embodiments.

### DETAILED DESCRIPTION

According to various embodiments, in obtaining a deformed image including a transformed nail region based on the transformation function and color values of the first nail region, the method may include: identifying pixels of coordinate values determined by applying the transformation function to each pixel of the first nail region; and obtaining the deformed image by assigning, to the identified pixels, the color values of the pixels of the first nail region.

According to various embodiments, in obtaining a deformed image including a transformed nail region based on the transformation function and color values of the first nail region, the method may include: identifying color values of pixels within the nail region that are determined by applying the transformation function to the second region of interest; and obtaining the deformed image by assigning, to pixels of the second region of interest, the identified color values of the pixels of the first nail region.

According to various embodiments, in a method of operating a server, the method may include: obtaining a nail image including a first nail region corresponding to a nail product worn on a nail; generating a mask image including a first region of interest corresponding to the first nail region; and generating a plurality of first points for the first region of interest, wherein distances between the plurality of first points are determined based on a predefined nail curvature. The method may further include: generating a plurality of second points for a second region of interest of a template image corresponding to the nail image; obtaining a transformation function based on a comparison result of coordinate values of the plurality of first points and the plurality of second points; obtaining a deformed image including a transformed nail region based on the transformation function and color values of the first nail region; and obtaining a printing file based on the deformed image and controlling a production facility to generate a gel nail by performing 3D printing based on the printing file.

According to various embodiments, in generating the plurality of first points for the first region of interest, the method may include: generating a plurality of corner points along an outline of the first region of interest and generating a central point at a center of the first region of interest; generating a plurality of outline points along the outline between the plurality of corner points; and generating a plurality of internal points from the central point toward each of the plurality of outline points.

According to various embodiments, in generating the plurality of internal points from the central point toward each of the plurality of outline points, the method may include: based on the predefined nail curvature, setting a first distance between first internal points in a first area closer to the central point and setting a second distance, shorter than the first distance, between second internal points in a second area farther from the central point.

According to various embodiments, a curvature of the nail corresponding to the first area is smaller than a curvature of the nail corresponding to the second area.

According to various embodiments, in obtaining the transformation function based on the comparison result of the coordinate values of the plurality of first points and the coordinate values of the plurality of second points, the method may include: identifying a first reference point among the plurality of first points and identifying a second reference point among the plurality of second points corresponding to the first reference point; and comparing coordinate values of points formed based on the first reference point among the plurality of first points with coordinate values of points formed based on the second reference point among the plurality of second points.

According to various embodiments, in obtaining a deformed image including a transformed nail region based on the transformation function and color values of the first nail region, the method may include: identifying pixels of coordinate values determined by applying the transformation function to each pixel of the first nail region; and obtaining the deformed image by assigning, to the identified pixels, the color values of the pixels of the first nail region.

According to various embodiments, in obtaining a deformed image including a transformed nail region based on the transformation function and color values of the first nail region, the method may include: identifying color values of pixels within the nail region that are determined by applying the transformation function to the second region of interest; and obtaining the deformed image by assigning, to pixels of the second region of interest, the identified color values of the pixels of the first nail region.

### 1. Nail 3D Printing System 1

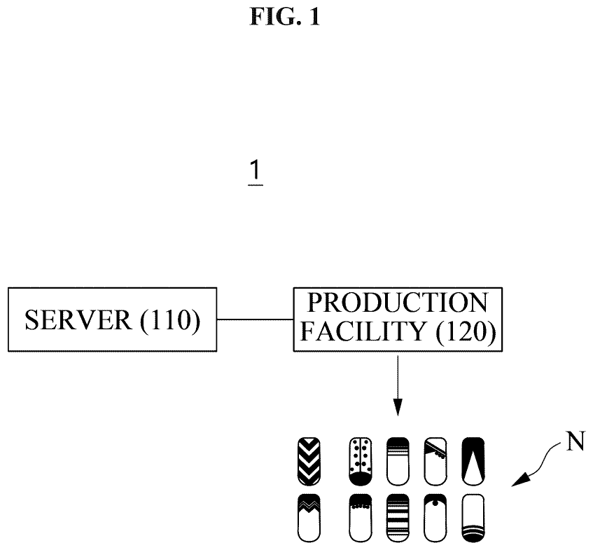

FIG. 1 is a block diagram of a nail 3D printing system 1 according to various embodiments.

According to various embodiments, the nail 3D printing system 1 may be a system configured to produce nail products, e.g., gel-nail stickers N by a 3D-printing method. The nail product may be a nail product that is adhesively attached to a user's (or consumer's) fingernail and, as shown in FIG. 1, may include a gel-nail sticker N shipped in a semi-cured state and cured by UV light, although the embodiments are not limited thereto.

In some embodiments See FIG. 1, the nail 3D printing system 1 may include a server 110 that generates a printing file for a nail product, e.g., a 3D-printable file format such as STL, OBJ, VRML, or PLY, and a production facility 120 that produces the nail product, e.g., a gel-nail sticker, using the generated printing file. The nail 3D printing system 1, e.g., the server 110, may receive various images for nail products from multiple global artists capable of high-quality designs, convert the received images into printing files, and thereby produce nail products, e.g., gel-nail stickers N that satisfy diverse consumer preferences. Accordingly, in a market where it has been difficult to meet ever-changing, diverse consumer demands, the system 1 enables a shift from a mass-production system for a small number of designs to a small-lot production system for a large number of high-quality designs, thereby improving consumer satisfaction with nail products, e.g., gel-nail stickers N. That is, the nail 3D printing system 1 may be configured to produce nail products capable of eliciting consumer satisfaction equal to or greater than that of services received at a nail salon.

According to various embodiments, the server 110 may be at least one electronic device operated by an administrator to provide, e.g., produce, ship, or distribute, nail products, e.g., gel-nail stickers N. The electronic device may include a PC such as a desktop, a smartphone, a tablet, and a wearable device, e.g., a smartwatch or AR/VR glasses, without limitation, and may include various types of electronic devices usable by an administrator, e.g., capable of executing programs.

According to various embodiments, the production facility 120 may include a 3D-printing device. For example, the 3D-printing device may be implemented as a device performing a 3D-printing process based on at least one of: a material-extrusion method such as FDM (fused deposition modeling) or FFF (fused filament fabrication; a photopolymerization method such as SLA Stereolithography), DLP (digital light processing), CLIP (continuous liquid interface production, LCD (liquid crystal display), or PuSL (projection micro-stereolithography); a powder-sintering method such as SLS, SLM (selective laser melting), DMLS (direct metal laser sintering), or MJP (multi-jet printing); a binder-jetting method such as CJP (color jet printing) or IJP (inkjet printing); a sheet-lamination method such as LOM (laminated object manufacturing), SDL (selective deposition lamination), or VLM (viscous lithography manufacturing); or a directed-energy deposition method such as DMT (laser-aided direct metal tooling), LMD (laser metal deposition) or LENS (laser engineered net shaping). Since 3D-printing methods are well-known, a detailed description is omitted.

### 2. Components of the Nail 3D Printing System 1

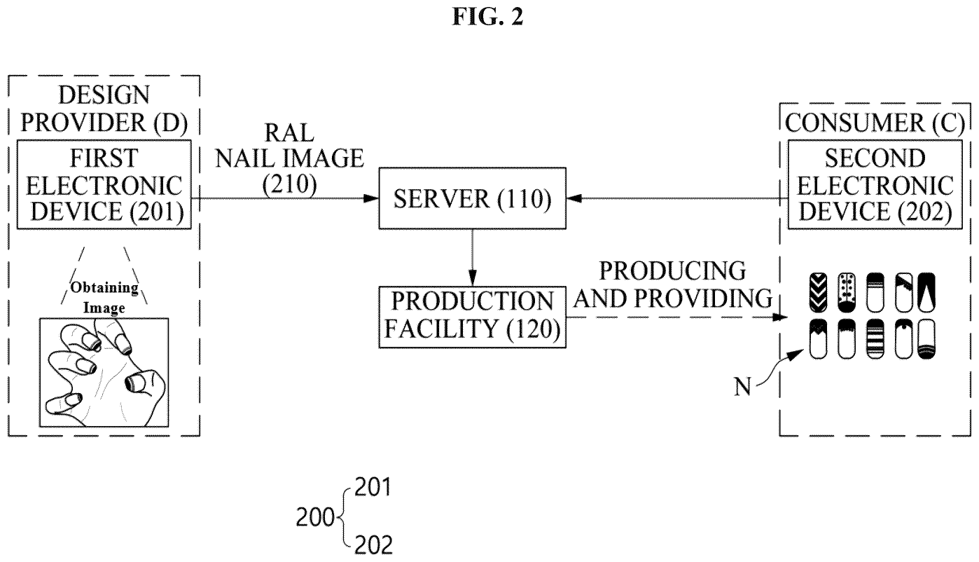

FIG. 2 is a diagram for explaining the nail 3D printing system 1 and an electronic device 200 using the same.

Referring to FIG. 2, the electronic device 200 using the nail 3D printing system 1, e.g., the server 110 and the production facility 120, may include a first electronic device 201 of design provider D who creates designs for a nail product, e.g., gel-nail sticker N and a second electronic device 202 of a consumer C who purchases the nail product, e.g., gel-nail sticker N. The electronic devices 200, e.g., the first device 201 and the second device 202, may include a PC such as a desktop, a smartphone, a tablet, or a wearable device, e.g., a smartwatch or AR/VR glasses, without limitation, and may include various types of electronic devices usable by users, e.g., design provider D, consumer C.

According to various embodiments, the first electronic device 201 may obtain an image (hereinafter, “nail image”) of a nail product, e.g., gel-nail sticker N produced by the design provider D and transmit the nail image to the server 110. The nail image may include a gel-nail sticker N and may be an image of a hand to which the gel-nail sticker N is attached. For example, the first electronic device 201 may obtain the nail image by photographing a hand with the gel-nail sticker N produced by the design provider D attached thereto and transmit the nail image to the server 110. Alternatively, the first electronic device 201 may obtain a nail image stored in the device 201 and transmit it to the server 110.

According to various embodiments, the nail image may include at least one nail product, e.g., gel-nail sticker N corresponding to at least one of all types of fingers, e.g., thumb, index, middle, ring, little. In one embodiment, the nail image may include a plurality of nail products, e.g., gel-nail stickers N corresponding respectively to all fingers, e.g., thumb, index, middle, ring, little. In this case, when not all nail products are included in the nail image to be transmitted to the server 110, the first electronic device 201 may prompt the design provider D to re-shoot an image including the nail products corresponding to all fingers or to upload an image including the nail products corresponding to all fingers. In another embodiment, multiple nail images may be used, each nail image including one nail product corresponding to a specific finger.

According to various embodiments, the second electronic device 202 may transmit, under control of the consumer C, a purchase request for a nail product, e.g., gel-nail sticker N to the server 110 by connecting or establishing communication thereto. Accordingly, the consumer may receive delivery of the nail product, e.g., gel-nail sticker N produced by the production facility 120.

### 2.1 Components of the Server 110 and the Production Facility 120

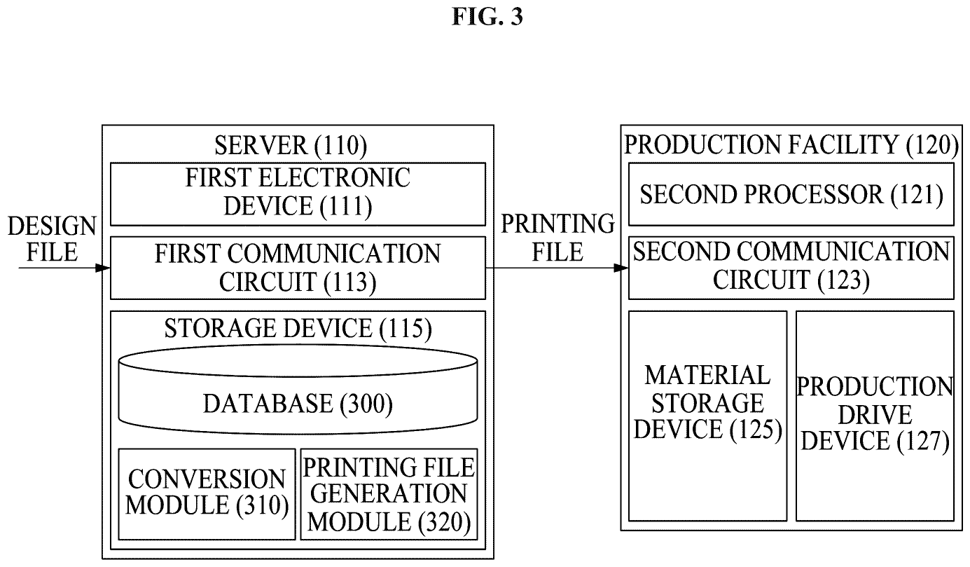

FIG. 3 is a block diagram illustrating an example of components of the server 110 and the production facility 120. The components will be described with reference to FIG. 3.

### 2.1.1 Components of the Server 110

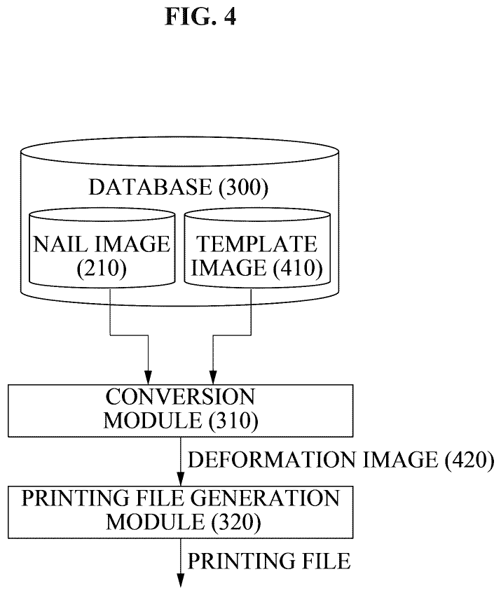

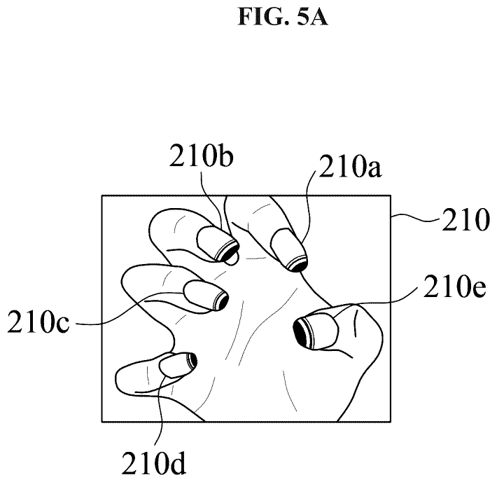

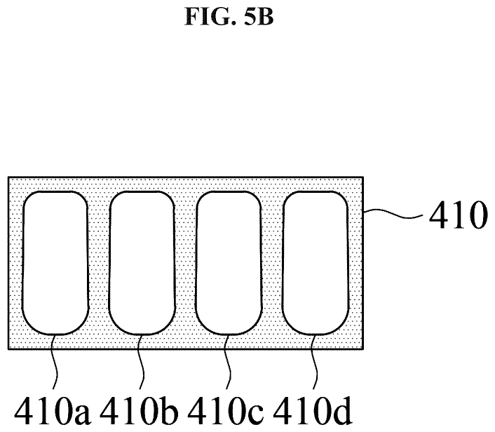

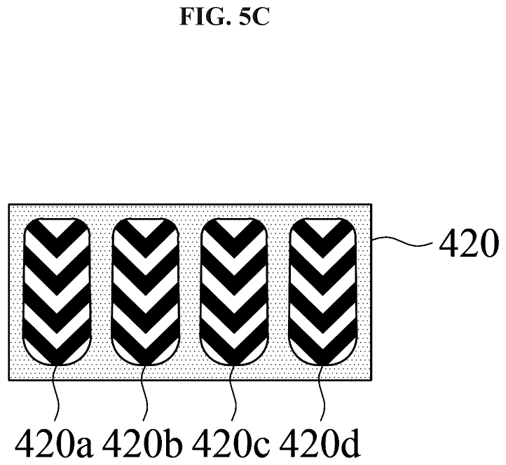

FIG. 4 is a diagram illustrating an example operation in which the server 110 generates a printing file. FIG. 5 illustrates examples of a nail image, a template image, and a deformed image. With FIG. 3, reference is made to FIGS. 4 and 5 to describe example components of the server 110.

According to various embodiments See FIG. 3, the server 110 may include a first processor 111, a first communication circuit 113, and a storage device 115, although the embodiments are not limited to the illustrated/described configuration and may include more or fewer components.

The first processor 111 may control components in the server 110, e.g., the first communication circuit 113, the storage device 115, and modules stored in the storage device 115. The first processor 111 may execute modules stored in the storage device 115, e.g., a transformation module 310 and a printing generation module 320, Software, computer code, program, or instructions, to control at least one other component, e.g., hardware or software, connected thereto and perform various data processing or computations. In one embodiment, as part of such processing or computations, the first processor 111 may load commands or data received from another component into volatile memory, process the commands or data stored in the volatile memory, and store resulting data in non-volatile memory. The first processor 111 may include a main processor, e.g., a central processing unit or application processor, and an auxiliary processor, e.g., a graphics processing unit, image signal processor, sensor hub processor, or communication processor, operable independently of or together with the main processor. Additionally or alternatively, the auxiliary processor may use less power than the main processor or be configured for a specific function. The auxiliary processor may be implemented separately from, or as part of, the main processor.

The first communication circuit 113 may establish a communication connection with an external electronic device, e.g., the production facility 120, and, based on the connection, transmit and/or receive data Signals, information. For example, the first communication circuit 113 may support establishment of a wired interface and/or a wireless communication channel and communication via the established channel. The first communication circuit 113 may include one or more communication processors operating independently of the first processor 111 and supporting wireless communication, without limitation.

The storage device 115 may store at least one piece of information data. For example, the storage device 115 may store a database 300, the transformation module 310, and the printing generation module 320.

The database 300 may include various types of information related to operation of the server 110 and, for example, as shown in FIG. 4, may store nail images 210 received from the design provider D and corresponding template images 410.

As shown in FIG. 4, the transformation module 310, when executed by the first processor 111, may generate a deformed image 420 based on a nail image 210 and a template image 410 stored in the database 300. FIG. 5 shows examples of a nail image 210, a template image 410, and a deformed image 420.

Referring to FIG. 5a, the nail image 210 may represent a photograph of an actual nail product. The nail image 210 may include images 210a, 210b, 210c, 210d, 210e of nail products, e.g., gel-nail stickers, placed on all fingers, e.g., thumb, index, middle, ring, little, although one nail image may include only one nail product. The nail image 210 may include nail regions 210a, 210b, 210c, 210d, 210e where nail products, e.g., gel-nail stickers, are located. The nail regions 210a-210e may include design elements of the nail product, e.g., drawings, colors, patterns, three-dimensional decorations.

Referring to FIG. 5b, the template image 410 may be a type of mask image including regions of interest 410a, 410b, 410c, 410d having a predefined shape, e.g., a nail shape with a first color, e.g., white (or a value of 1), and a background region 411 having a second color, e.g., black, (or a value of 0). Each region of interest 410a-410d may correspond to a particular finger, e.g., thumb, index, middle, ring, little. A template image for the thumb may be implemented separately. Moreover, without limitation, multiple template images may be implemented with different regions of interest for respective images. In this case, the database 300 may store a plurality of template images having different shapes of regions of interest. The server 110, e.g., the first processor 111, may select a specific template image 410 including a region of interest corresponding to the shape of the nail region included in the nail image 210 from among the plurality of template images and perform an operation of obtaining a transformation function for the nail image 210 based on the selected template image 410.

Referring to FIG. 5c, the deformed image 420 may include transformed nail regions 420a, 420b, 420c, 420d—which are transformed from the nail regions 210a, 210b, 210c, 210d, 210e in the nail image 210—and a background region 420. The shapes of the transformed nail regions 420a-420d may be convertible into a printing file for 3D printing. Without limitation, the deformed image 420 may be implemented such that flattened images are included respectively for multiple images, e.g., video frames.

As shown in FIG. 4, the printing generation module 320 may generate a printing file in a 3D-printable format, e.g., STL, based on the transformed nail regions 420a-420d included in the deformed image 420, allowing the production facility 120 to perform 3D printing.

### 2.1.2 Components of the Production Facility 120

Referring to FIG. 3, the production facility 120 may include a second processor 121, a second communication circuit 123, a material storage device 125, and a production drive device 127, although the embodiments are not limited thereto and may include more or fewer components. The second processor 121 and the second communication circuit 123 may be implemented in the same manner as the first processor 111 and the first communication circuit 113, respectively, and redundant descriptions are omitted.

The material storage device 125 may store materials for producing the nail product, e.g., gel-nail sticker N. For example, as shown in Table 1 below, the nail product, e.g., gel-nail sticker N includes multiple layers, e.g., a release-film layer, a gel layer, a printing layer, a color layer, an adhesive layer, and a peel-off film layer, each of which may be formed of a specific material; hence, the storage device 125 may store the materials listed in Table 1.

TABLE 1

| Layer of nail product | Material |
|---|---|
| Release-film layer | Transparent or translucent film |
| Gel layer | Includes 5 to 60 parts by weight of |
| | UV-curable resin and 40 to 95 parts by |
| | weight of thermosetting resin |
| Printing layer | Various materials for aesthetics such |
| | as patterns printed by various printing |
| | techniques, mica, fine particles, etc. |
| Color layer | For expressing background colors of |
| | the gel-nail sticker; pigments of various |
| | colors, or pigments mixed into the UV- |
| | curable resin forming the gel layer |
| Adhesive layer | Adhesive that cures while drying at |
| | room temperature |
| Peel-off film layer | Transparent or translucent materials; |
| | examples include films with fluorinated |
| | surface treatment and silicone-based coatings |

The production drive device 127 may include at least one member for producing the nail product, e.g., gel-nail sticker N by 3D-printing based on the materials stored in the material storage device 125. For example, the at least one member may include a nozzle for dispensing material, a tube, and a drive member for moving the nozzle. Since components of 3D printers are well-known, detailed descriptions are omitted.

### 2.2 Components of the Electronic Device 200

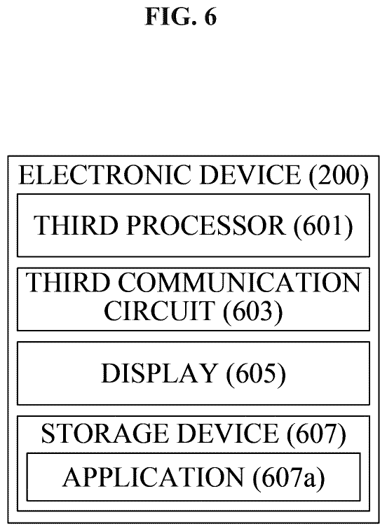

FIG. 6 is a block diagram showing components of the electronic device 200.

Referring to FIG. 6, the electronic device 200 may include a third processor 601, a third communication circuit 603, a display 605, and a storage device 607 storing an application 607a, although the configuration is not limited thereto. The third processor 601 and the third communication circuit 603 may be implemented as described above for the first processor 111 and the first communication circuit 113, respectively.

The display 605 may visually provide information to the exterior of the electronic device 200, e.g., a user. For example, the display 605 may present an interface for the design provider D to capture and upload images of a nail product, e.g., gel-nail sticker N to the server 110 and/or present a screen for the consumer C to browse a list of nail products. The display 605 may include, for example, a display panel, a hologram device, or a projector and a control circuit therefor. In one embodiment, the display 605 may include touch circuitry configured to sense touches and/or sensor circuitry, e.g., a pressure sensor, configured to measure a force generated by the touch.

The storage device 607 may store information data associated with the electronic device 200. For example, the storage device 607 may store an application 607a distributed by an administrator of the server 110. The application 607a may be implemented to provide functions such as presenting an interface for the design provider D to capture and upload images of a nail product, e.g., gel-nail sticker N to the server 110 and/or presenting a screen for the consumer C to recognize a list of nail products.

### 3. Operation Method of the Server 110

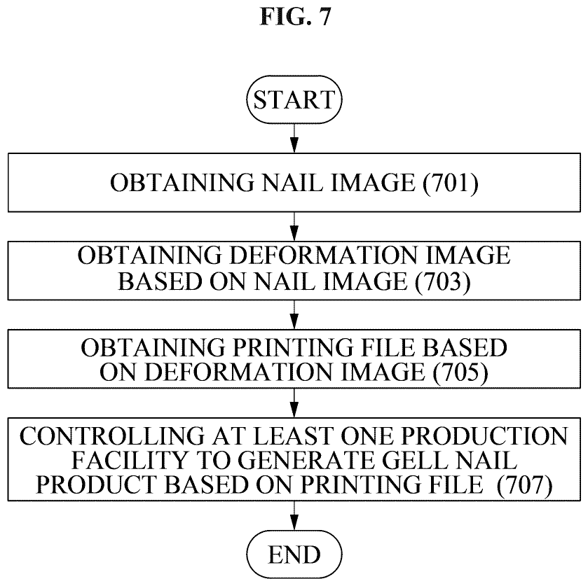

FIG. 7 is a flowchart illustrating an example of an operation of generating a nail product by the server 110. The operations may be performed regardless of the illustrated/described order, and more or fewer operations may be performed.

In operation 701, the server 110, e.g., the first processor 111, may obtain a nail image 210. For example, the first electronic device 201 may obtain, e.g., photograph, an image including a high-quality gel-nail sticker N produced by the design provider D and transmit it to the server 110. Thus, the server 110 may receive images related to nail products from global artists in various countries via the electronic device 201. Alternatively, the server 110 may establish communication with a separate storage device (not shown and obtain a nail image 210 stored therein, or connect to an external server (not shown to receive a nail image 210 stored thereon.

In operation 703, the server 110, e.g., the first processor 111, may obtain a deformed image 420 based on the nail image 210. For example, to facilitate generation of a printing file, the server 110 may transform a nail region, e.g., nail regions 210a-210e in FIG. 5(a) corresponding to a nail product within the nail image 210 and obtain a deformed image 420 including transformed nail regions, e.g., nail regions 420a-420d in FIG. 5(c). The nail-region transformation may be performed based on a transformation function (or warping function), as described later. Accordingly, a specific pixel of the transformed nail region in the deformed image 420 may correspond to, but have a different coordinate value from, a specific pixel of the nail region of the nail image 210.

In operation 705, the server 110 may obtain a printing file based on the deformed image 420.

In operation 707, the server 110 may control at least one production facility 120 to generate a gel-nail product, e.g., a gel-nail sticker N based on 3D printing using the printing file. For example, the server 110, e.g., the first processor 111, may transmit the printing file together with a control signal to the production facility 120 to produce the gel-nail product based on the printing file.

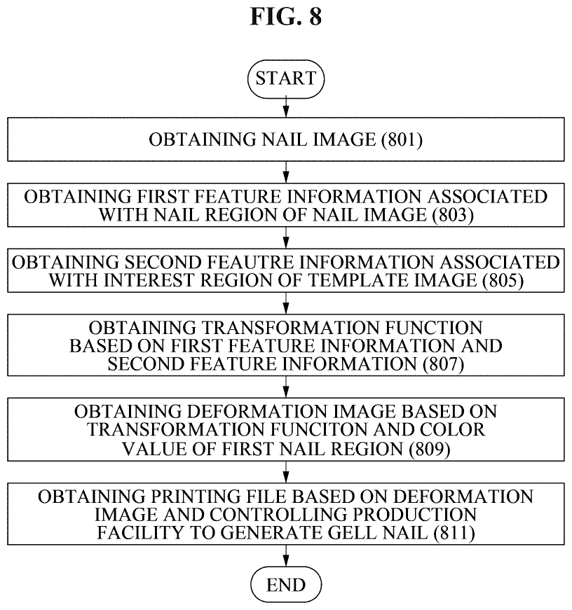

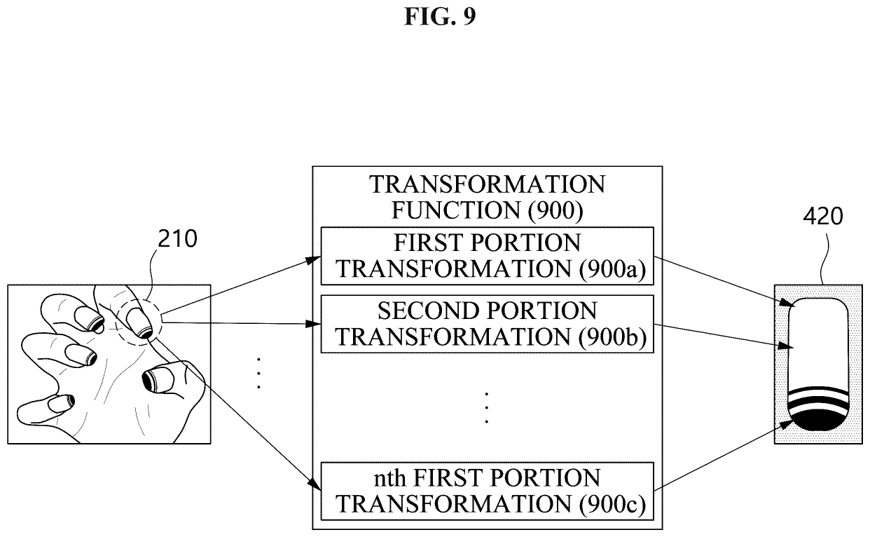

FIG. 8 is a flowchart illustrating an example operation of transforming a nail image based on a transformation function 900 of the server 110. The operations may be performed regardless of the illustrated/described order, and more or fewer operations may be performed. With reference to FIG. 9, the process of FIG. 8 is further described.

FIG. 9 is a diagram illustrating an example operation of converting the nail image 210 into the deformed image 420 based on the transformation function 900.

In operation 801, the server 110 may obtain the nail image 210.

In operation 803, the server 110 may obtain first feature information associated with a nail region in the nail image 210, and in operation 805 may obtain second feature information associated with interest region in the template image 410, and in operation 807 may obtain transformation information based on the first and second feature information. For example, referring to FIG. 9, the first feature information may be coordinate information for the nail region of the nail product in the nail image 210 in a first coordinate system (u, v), and the second feature information may be coordinate information for the region of interest in the template image 410 in a second coordinate system (x, y). The coordinate information may include at least one of coordinate values of points (or pixels) on an image and a function (or array) connecting the coordinate values. The server 110 may generate the transformation function 900 by comparing the first feature information for the nail region 910 with the second feature information for the region of interest 920. The transformation function 900 may include transformation information 900a, 900b, 900c, e.g., parameters, matrix weights) for converting coordinate values of pixels in one coordinate system to coordinate values of pixels in another coordinate system. The transformation function 900 may include at least one of a first-direction function for converting from the first coordinate system (u, v) associated with the nail image 210 to the second coordinate system (x, y) associated with the template image 410, and a second-direction function for converting from the second coordinate system (x, y) to the first coordinate system (u, v). The transformation function 900 may be a matrix value for warping, but is not limited thereto.

In operation 809, the server 110 may obtain a deformed image 420 including a transformed nail region based on the transformation function 900 and color values of the nail region. In one embodiment, when the transformation function 900 is a first-direction function, the server 110 may generate the deformed image 420 by applying the transformation function to pixel-by-pixel coordinate values, e.g., (u1, v1), of the nail region 910 of the nail image 210 and generating pixels having modified coordinate values, e.g., x1, y1). In another embodiment, when the transformation function 900 is a second-direction function, the server 110 may apply the transformation function 900 to pixels having coordinate values, e.g., x1, y1), within the region of interest 920 of the template image 410, identify color values of corresponding pixels having coordinate values, e.g., (u1, v1), within the nail region 910 of the nail image 210, and assign the identified color values to pixels within the region of interest 920 of the template image 410, thereby generating the deformed image 420 including a transformed nail region.

In operation 811, the server 110 may obtain a printing file based on the deformed image 420 and control the production facility 120 to generate a gel nail. For example, the server 110 may convert the deformed image 420 including the transformed nail region into a vector image and generate the printing file based on the vector image. The vector image may include vector images for segmented regions within the deformed image 420, without limitation.

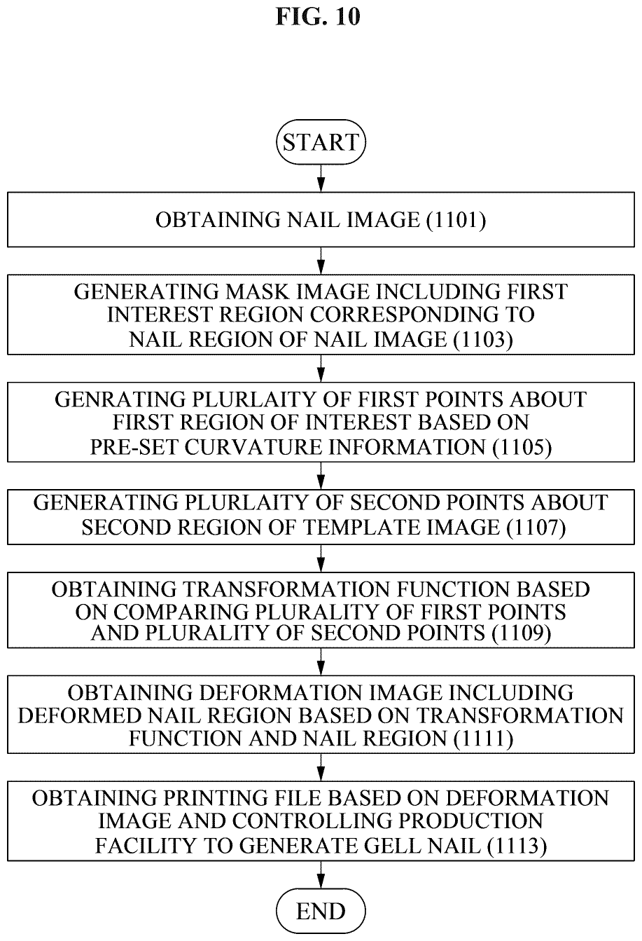

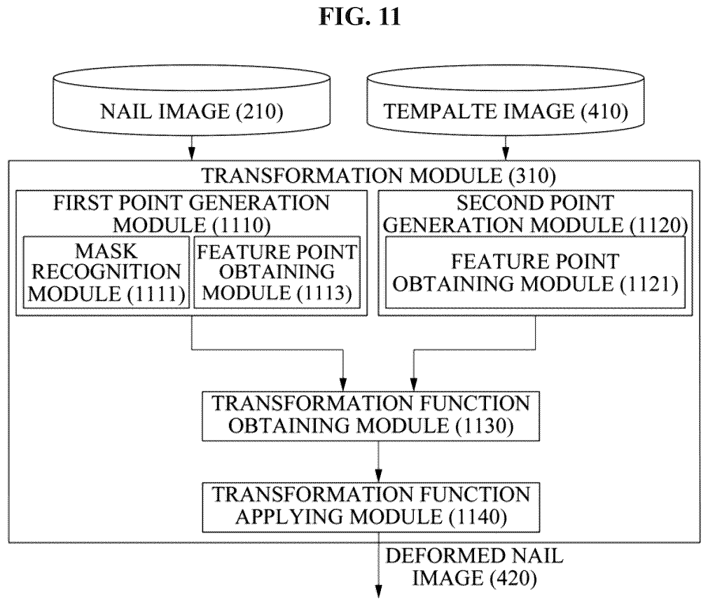

FIG. 10 is a flowchart illustrating an example of generating a gel nail based on transformation of a nail image by the server 110. With reference to FIGS. 11-16, the process of FIG. 10 is further described.

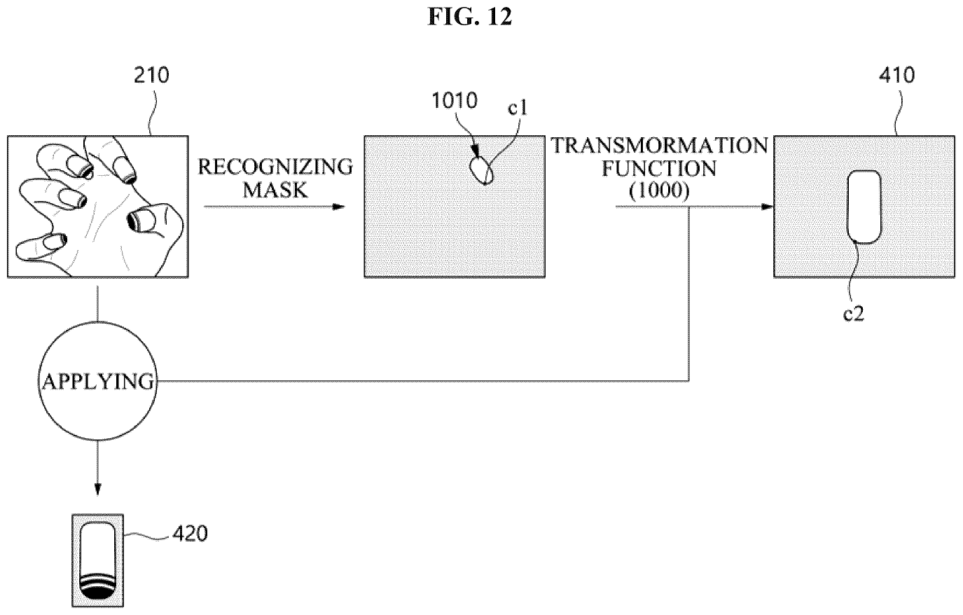

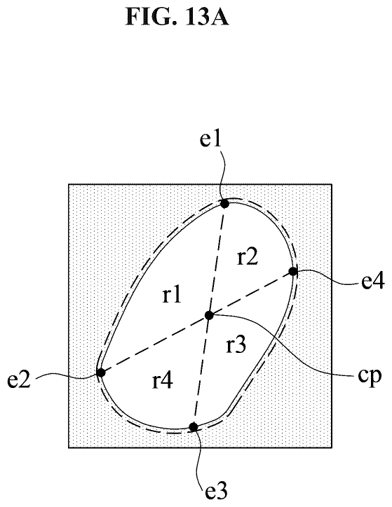

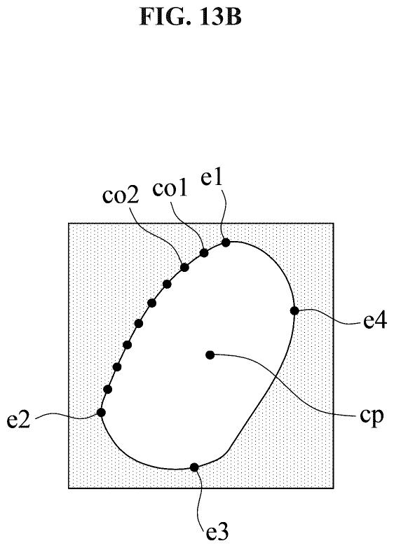

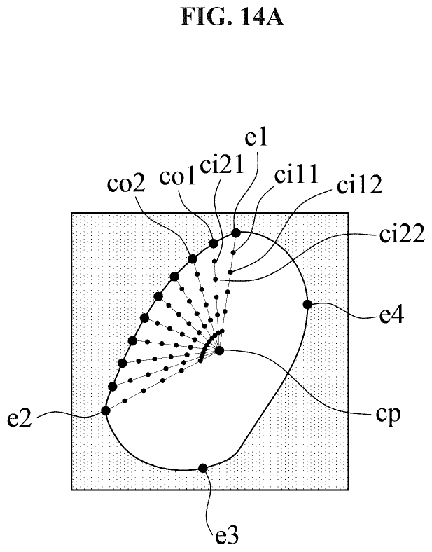

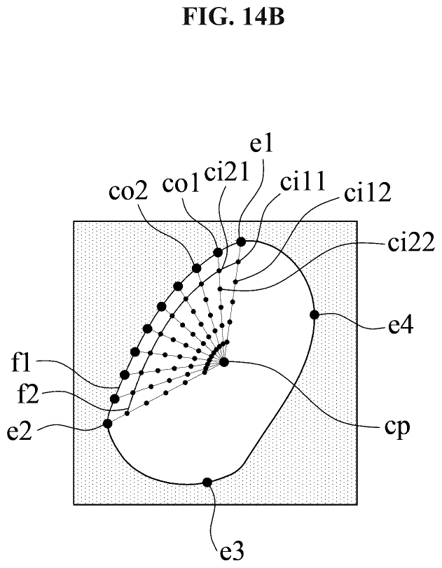

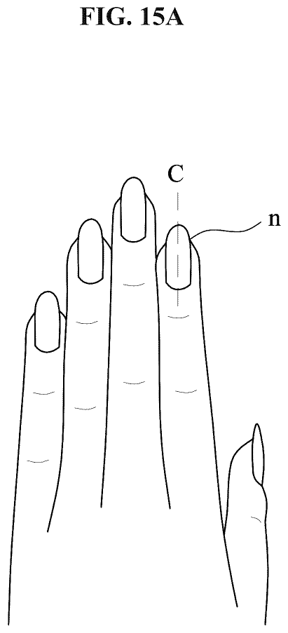

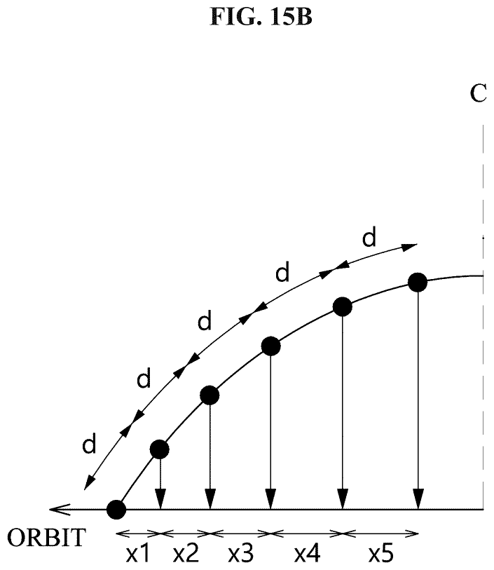

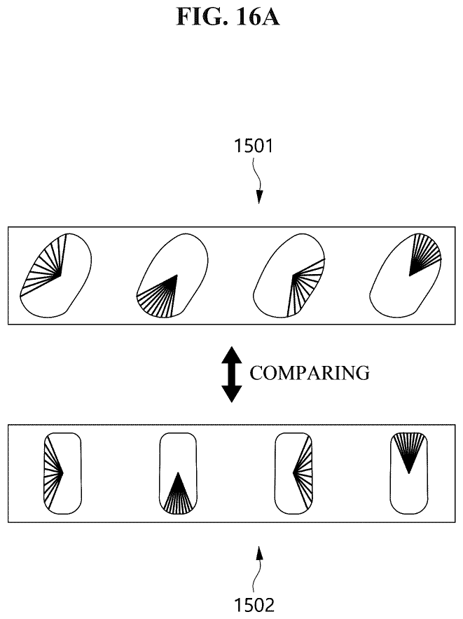

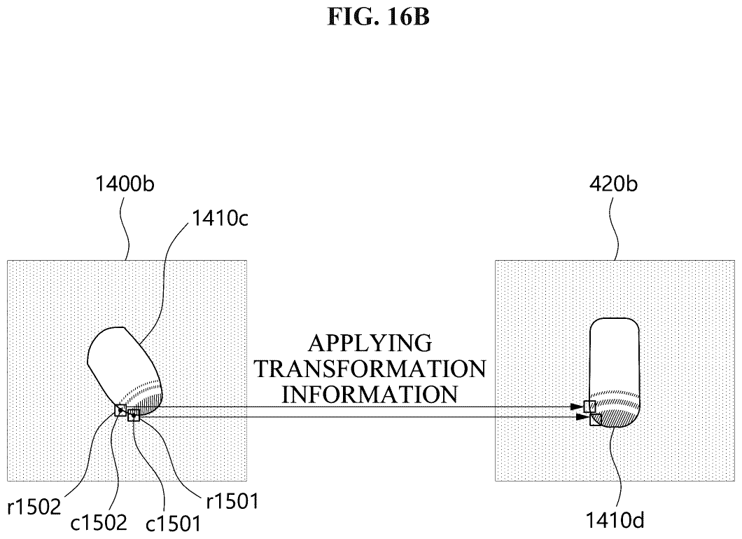

FIG. 11 illustrates example operations of modules for obtaining a deformed image 420. FIG. 12 illustrates an example operation of generating a deformed image 420. FIGS. 13 and 14 illustrate example operations of generating points for a mask image by the server 110. FIG. 15 illustrates an example of intervals between points generated on a mask image based on a predefined nail curvature. FIGS. 16A and 16B illustrate example operations of comparing points of a mask image and points of a template image.

In operation 1001, the server 110 may obtain a nail image 210, and in operation 1003 may generate a mask image 1400a including a first region of interest 1410a corresponding to a nail region in the nail image 210. Referring to FIGS. 11 and 12, the server 110 may obtain the mask image 1400a including the first region of interest 1410a corresponding to the nail region for the nail image 210 using a mask recognition module 1111 of a first-point generation module 1010. The mask recognition module 1111 may perform operations based on an object-recognition algorithm that separates the nail region, such as a segmentation algorithm, e.g., Segment Anything. Although a single-nail mask (for a specific finger) is described for convenience, the method may also be applied to a mask including multiple regions of interest corresponding to multiple nail regions, e.g., for all fingers.

In operation 1005, the server 110 may generate a plurality of first points for the first region of interest 1410a based on predefined curvature information. Using a feature-point obtaining module 1113 of the first-point generation module 1010, the server 110 may generate the plurality of first points for the first region of interest 1410a within the mask image 1400a. Generating points may mean selecting (or extracting) specific pixels from the image region, e.g., the first region of interest 1410a. For example, referring to FIGS. 13 and 14, points may be generated in a fan shape from a central point cp toward each corner and edge, across multiple regions of the mask image 1400a. As shown in FIG. 15, the distances x1, x2, x3, x4, x5 between the points may be determined based on the predefined curvature of the nail (n. The coordinate information of the plurality of points may be used to obtain the aforementioned transformation function 900.

For example, referring to FIG. 13a, the server 110 may extract (or obtain, or generate) a plurality of corner points e1, e2, e3, e4 corresponding to four corners of the nail region in the mask image 1400a and extract (or obtain, or generate) a central point cp. The corner points can serve as reference points for comparison with points of the template image 410, such that coordinate information of the plurality of first points of the first region of interest 1410a can be compared with coordinate information of a plurality of second points of a second region of interest 1431 of the template image 410. Based on the central point cp and the plurality of corner points e1-e4, a plurality of regions r1-r4 may be defined.

Referring to FIG. 13b, the server 110 may extract (or obtain, or generate), along the outline of the nail region, a plurality of outline points co1, co2 between the two corner points e1, e2 for a specific region, e.g., the first region r1 among the plurality of corner points e1-e4. In one example, the number of the corner and outline points for the specific region may be set to ten, but is not limited thereto. The server 110 may compute an arc function connecting the outline points co1, co2 and identify two-dimensional coordinates, e.g., x, y, based on the computed arc function so as to extract the outline points with the identified coordinates.

Referring to FIG. 14a, the server 110 may extract (or obtain, or generate) a plurality of internal points ci21, ci22, ci11, ci12 from the central point cp toward each of the plurality of corner points e1, e2 and the plurality of outline points co1, co2 included in the specific region, e.g., first region r1. Points arranged in a specific direction, e.g., e1, ci11, ci12 may be grouped as a point group. In one embodiment, the distances between the plurality of internal points arranged toward a specific direction may be set to predefined distances. For example, as shown in FIG. 15, the server 110 may determine distances x1-x5 between internal points within a group based on information on the curvature of the nail n. The curvature of the nail n may be that of the wearer's fingernail, or an average fingernail curvature. Where 3D distances d to an outer surface are equal along a centerline c, 2D distances x1-x5 between points may be shorter farther from the centerline and longer closer to the centerline. Thus, the server 110 may set a larger spacing between first internal points in areas near the central point, e.g., where curvature is gentle/small and a smaller spacing, e.g., higher density, between second internal points in areas where curvature is steep/large, e.g., areas far from the center or near edges. The number of internal points for different directions may be set equal, but is not limited thereto.

Referring to FIG. 14b, the server 110 may compute feature functions f1, f2 connecting points positioned on the same orbit, e.g., same order, across different directional groups, e.g., e1, co1, co2; or ci11, ci21. The operations for obtaining points may be based on an AI model using a CNN, without limitation.

In operation 1007, the server 110 may obtain a plurality of second points for the second region of interest 1410b of the template image 410. The server 110 may obtain a template image 410 having a second region of interest 1410b whose shape corresponds to the nail region (or the first region of interest 1410a from among a plurality of template images. Like the mask image 1400a, the template image 410 may include the second region of interest 1410b and a background region 1420b. Using a feature-point obtaining module 1121 of a second-point generation module 1120, the server 110 may generate the plurality of second points for the second region of interest 1410b. In this case, the module 1121 may be implemented not to set distances between the plurality of second points based on nail curvature, without limitation.

The server 110 may also extract at least one reference point for each of the mask image 1400a and the template image 410, serving as a basis for forming other outline points and internal points, e.g., the corner points e1-e4. Based on the reference points extracted for each image, coordinate values of other points may be compared with each other. That is, reference points in a first coordinate system (x, y) for the nail image 210 and reference points in a second coordinate system (u, v) for the template image 410 are matched, such that coordinate values of outline and internal points formed based on the respective reference points are comparable. For example, coordinates of outline points formed based on a first reference point in the first coordinate system may be compared with coordinates of outline points formed based on a matched second reference point in the second coordinate system.

As shown in FIG. 16A, the server 110 may thus obtain the plurality of first points 1501 for the nail image 210 (or mask image 1400a and the plurality of second points 1502 for the template image 410.

In operation 1009, the server 110 may obtain a transformation function based on a comparison of the plurality of first points and the plurality of second points, using a transformation-function obtaining module 1130. As shown in FIG. 16A, a transformation function, e.g., the function 900 of FIG. 9 may be obtained based on the comparison. The transformation function 900 may be implemented as a first-direction transformation function that converts coordinates of point c1 into coordinates in the coordinate system of point c2, or as a second-direction transformation function that converts coordinates of point c2 into coordinates in the coordinate system of point c1. The transformation function 900 may include transformation information, e.g., parameters, matrix weights, for converting coordinate values not only for the plurality of points, e.g., the plurality of first and second points, (or pixels) but also for pixels between those points. For example, transformation information for pixels between points may be generated based on interpolation of transformation information of surrounding points.

The server 110 may compare the plurality of first points 1511-1514 formed based on reference points generated in the first coordinate system with the plurality of second points 1521-1524 formed based on corresponding reference points generated in the second coordinate system.

In operation 1011, the server 110 may obtain a deformed image 420 including a transformed nail region 1410d based on the transformation function 900 and the nail region 1410c, and in operation 1013 may obtain a printing file based on the deformed image 420 and control the production facility 120 to generate a gel nail. For example, referring to FIG. 12, when the transformation function 900 is a first-direction function, the server 110 may obtain a deformed image 420 including a transformed nail region 1420d and a background region 1420d by applying the transformation function 900 to a mask image 1400b including a nail region 1410c and a background region 1420c. When the transformation function 900 is a second-direction function, the server 110 may, by applying the transformation function 900 to each pixel of the second region of interest 1410b of the template image 410, identify color values of pixels of the nail region and assign the identified color values to the pixels of the second region of interest 1410b of the template image 410, thereby obtaining the deformed image 420 including the transformed nail region 1420d and the background region 1420d.

Referring to FIG. 16B, when applying the transformation function 900 to each pixel of the second region of interest 1410b of the template image 410, the server 110 may identify coordinate values for identifying a specific pixel c1501, c1501 of the nail region. If such coordinate values cannot be identified, the server 110 may set the color value of the corresponding pixel of the second region of interest 1410b based on color values of pixels belonging to a region r1502, r1501 that includes the coordinate value, e.g., an average over a neighborhood. The region may be an area within a predefined pixel distance, e.g., four pixels within a one-pixel radius, from the coordinate value.

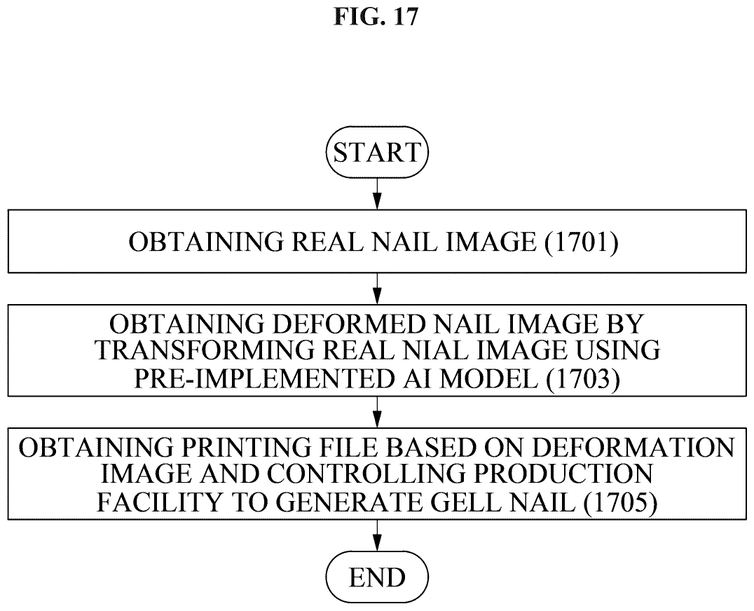

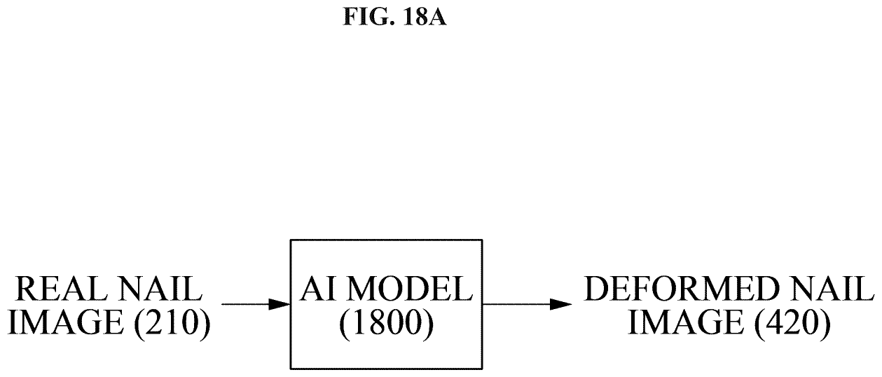

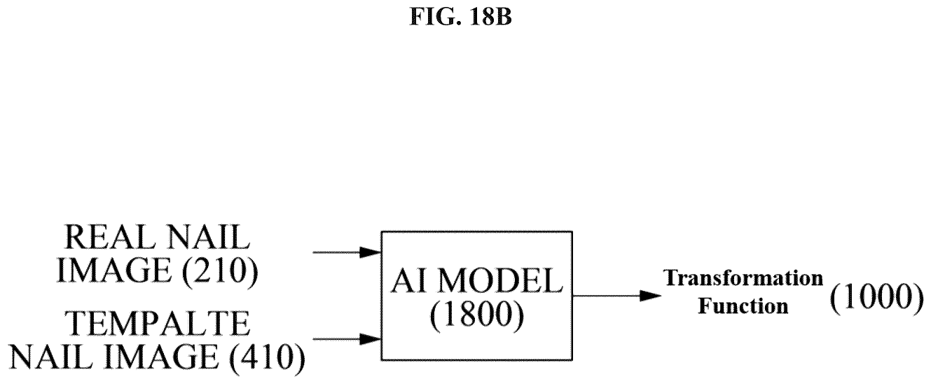

FIG. 17 is a flowchart illustrating an example of obtaining a transformed nail image based on an artificial intelligence model of the server 110. With reference to FIG. 18, further details are provided.

FIG. 18 illustrates examples of an artificial intelligence model 1800.

In operation 1701, the server 110 may obtain a nail image.

In operation 1703, the server 110 may transform the nail image 210 using a pre-implemented AI model 1800 to obtain a deformed image 420.

In one embodiment See FIG. 18(a), an AI model 1800 may be used that outputs a deformed image 420 corresponding to an input nail image 210. The AI model 1800 may be trained using deformed images 420 obtained via the above-described process of obtaining the transformation function 1000 for nail images 210 of various global artists. Based on various learning algorithms, the AI model 1800 may be implemented by training with the nail image 210 as input data and the corresponding deformed image 420 as output data.

In another embodiment See FIG. 18(b), an AI model 1800 may be used that outputs a transformation function 1000 based on at least one of a nail image 210 and a corresponding template image 410 as input. Applying the transformation function 1000 output from the AI model 1800 to the nail image 210 yields the deformed image 420. The AI model 1800 may be trained using nail images 210 of various global artists, corresponding template images 410, and transformation functions 1000 obtained therefrom.

In operation 1705, the server 110 may obtain a deformed image 420, obtain a printing file, and control the production facility 120 to generate a gel nail.

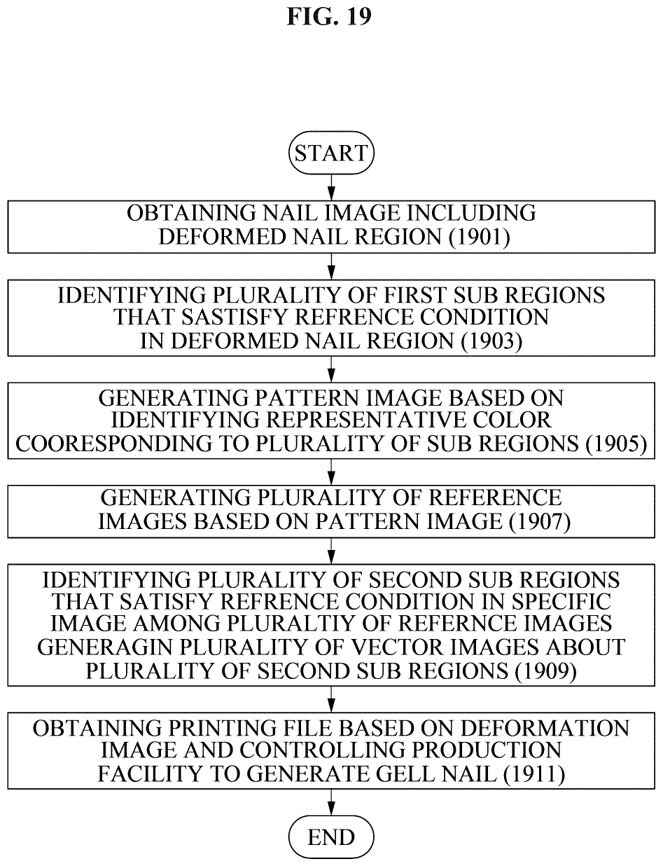

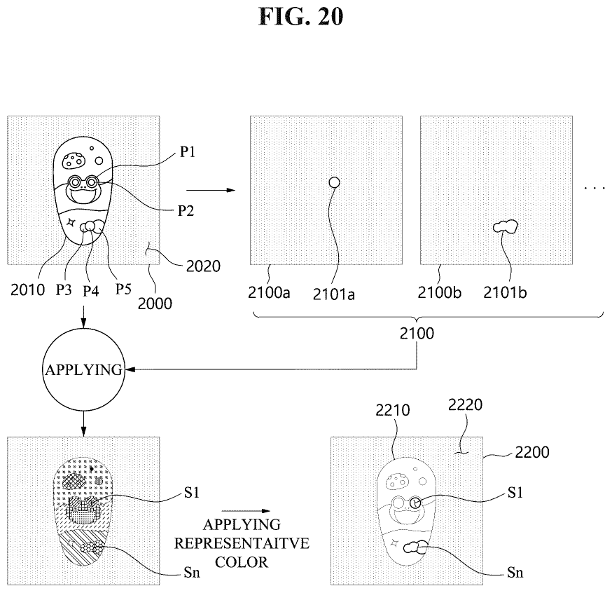

FIG. 19 is a flowchart illustrating an example operation of generating a printing file based on a deformed image. With reference to FIGS. 20-24, further details are provided.

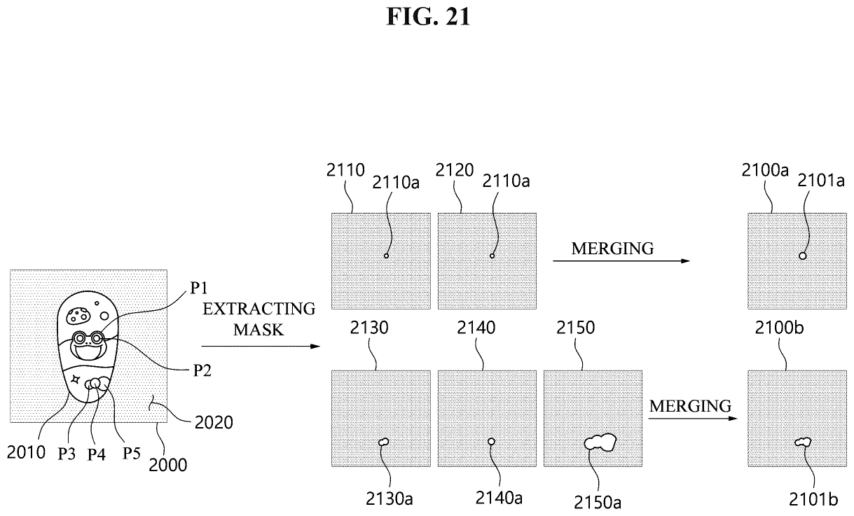

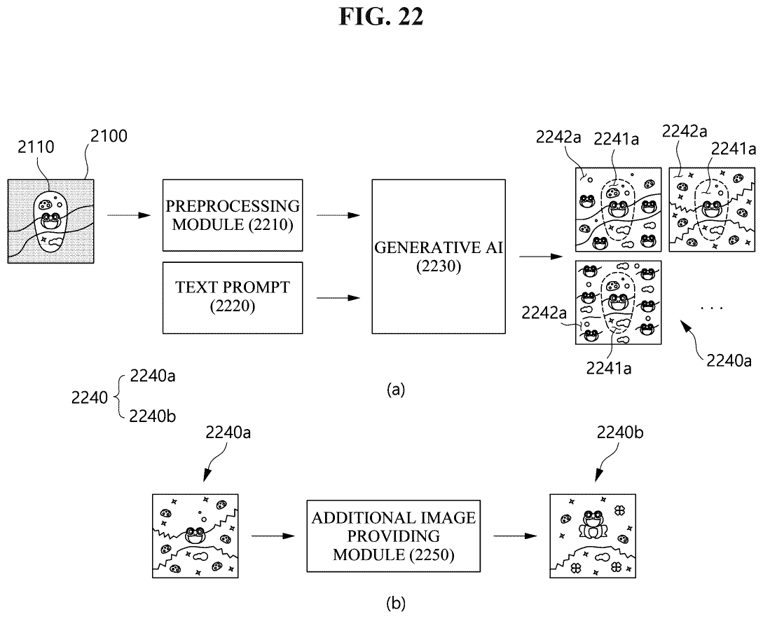

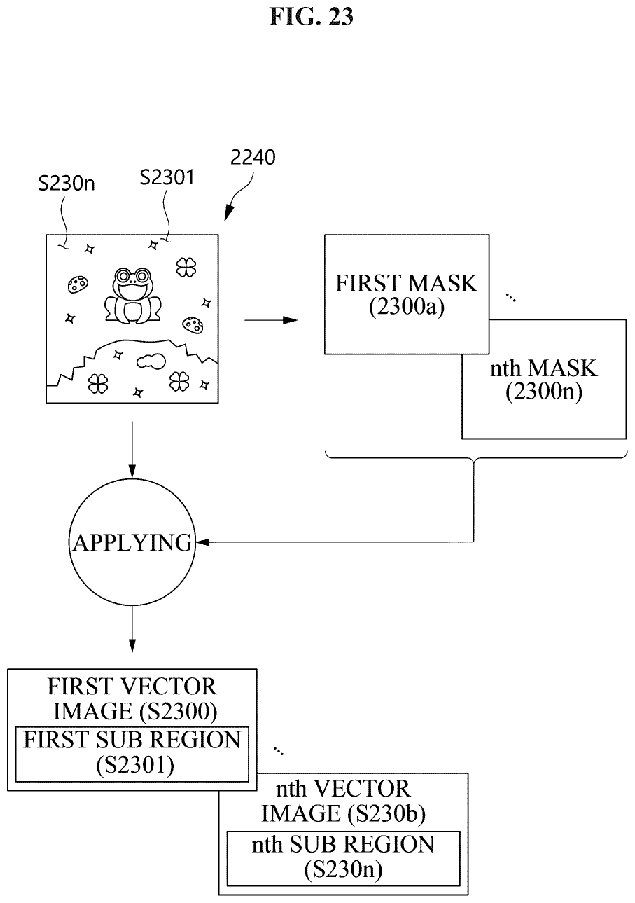

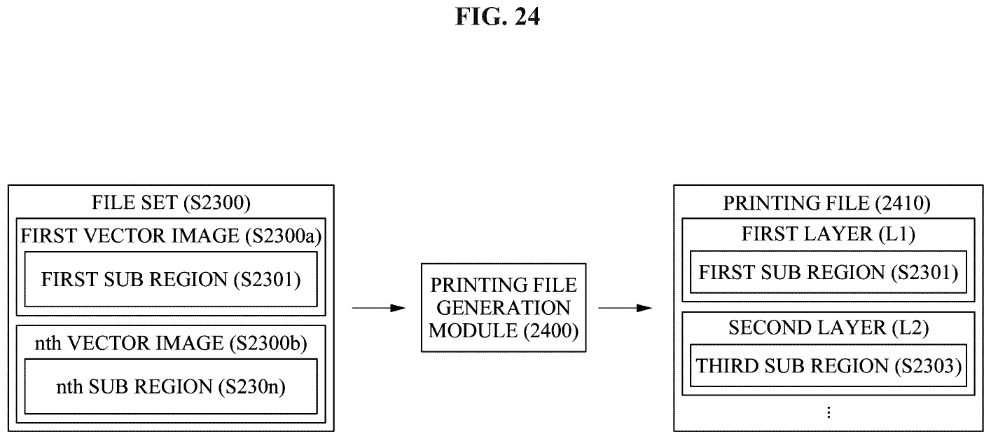

FIG. 20 illustrates an example operation of obtaining information for respective sub-regions of a deformed image. FIG. 21 illustrates an example operation of generating a first pattern image based on information for respective sub-regions. FIG. 22 illustrates an example operation of generating a plurality of second pattern images based on the first pattern image. FIG. 23 illustrates an example operation of vectorizing a specific pattern image among the plurality of pattern images. FIG. 24 illustrates an example operation of generating a printing file.

In operation 1901, the server 110 may obtain a nail image 2000 including a transformed nail region. Referring to FIG. 20, the nail image 2000 may be the deformed image 420 described above. The nail image 2000 may include a nail region 2010 including a plurality of nail components P1, P2, P3, P4, P5 and a background region 2020. Each of the plurality of nail components P1-P5 may include design elements such as drawings and patterns. Because the nail image 2000 is generated based on an actual photographed nail image 210, colors of the nail components P1-P5 may appear blotchy due to various factors, e.g., stains, ambient lighting, and thus differences among color values of pixels for the nail components P1-P5 may be greater than a predefined value. The predefined value may be an upper limit enabling conversion into a printing file, e.g., an upper limit allowing conversion into a vector image.

In operation 1903, the server 110 may identify a plurality of first sub-regions S1, Sn within the transformed nail region 2010 that satisfy a reference condition and, in operation 1905, may generate a pattern image 2200 based on identifying representative colors corresponding to the plurality of sub-regions. For example, as shown in FIG. 20, by performing segmentation to separate graphically meaningful objects of the nail region 2010 of the nail image 2000, the server 110 may identify the plurality of first sub-regions S1, Sn. Each of the plurality of first sub-regions S1, Sn may satisfy a non-overlap condition. By identifying a representative color for each of the plurality of first sub-regions S1, Sn, the server 110 may generate a pattern image 2200 including the plurality of first sub-regions S1, Sn with the representative colors assigned. Differences among color values of pixels corresponding to the sub-regions S1, Sn of the pattern image 2200 may be smaller than the aforesaid predefined value, thereby enabling generation of a printing file based on the pattern image 2200.

To identify the plurality of first sub-regions S1, Sn, the server 110 may generate a plurality of masks 2100a, 2100b including non-overlapping regions of interest 2101a, 2101b by performing a segmentation operation on the nail region 2010 and merging/excluding preliminary masks 2110, 2120, 2130, 2140, 2150 output from an AI model (or API). The server 110 may also determine overlap amounts, e.g., IoU, among regions of interest, merge highly overlapping groups, and/or exclude preliminary masks whose region size is below a preset threshold.

The server 110 may identify the plurality of sub-regions S1 . . . Sn by applying the masks 2100a, 2100b to the nail image 2000, crop an internal rectangular image maximized within each sub-region (touching the contour), and identify a representative color for the cropped area, e.g., an average or clustering-based representative.

Attributes, e.g., size and color, of the sub-regions S1, Sn of the pattern image 2200 may differ from attributes of the nail components P1-P5 of the nail image 2000. For instance, a sub-region S1 may encompass both a character's eye P1 and pupil P2, and another sub-region Sn may encompass multiple water-drop elements P3-P5, e.g., as a result of merging preliminary masks. Colors of the sub-regions may also differ from colors of the corresponding components because representative colors are assigned.

In operation 1909, the server 110 may generate a plurality of reference images based on the pattern image. Referring to FIG. 22, the plurality of reference images 2240 may be images whose similarity to the pattern image 2110 is above a preset threshold.

In FIG. 22a, the server 110 may generate at least one first reference image 2240a based on the pattern image 2110 and a generative AI 2230. For example, the server 110 may input a preprocessed image generated by a preprocessing module 2210 from the pattern image 2100 together with a text prompt 2220 into the generative AI 2230 and obtain the first reference image 2240a as output. The first reference image 2240a may include an image region 2241a corresponding to the nail region 2110 and a remaining region 2242a including design elements generated based on the nail region. The preprocessing may extract an inner area offset inward from the nail-region outline by a preset pixel distance to prevent the generative model from recognizing the background, thereby yielding higher-quality candidates. The text prompt 2220 may include instructions such as “generate an image with a connecting pattern” or “generate an image that naturally connects from the mask area.”

In FIG. 22b, the server 110 may generate a second reference image 2240b using a similar-image retrieval module 2250 based on the first reference image 2240a.

In operation 1909, the server 110 may identify a plurality of second sub-regions S2301, S230n satisfying a reference condition within a selected reference image 2240 among the plurality of reference images and generate a plurality of vector images for the plurality of second sub-regions. Referring to FIG. 23, the server 110 may receive a user selection of a specific reference image 2240, generate masks, e.g., first mask 2300a . . . nth mask 2300n, for the reference image 2240, apply the masks to obtain the second sub-regions, e.g., S2301 . . . S230n, and generate respective vector images, e.g., S2300a . . . S2300n therefor. The vector images may be, for example, SVG or AI files.

In operation 1911, the server 110 may generate a printing file based on at least some of the plurality of vector images and control the production facility to generate a gel nail. Referring to FIG. 24, the server 110 may generate the printing file 2410 by assigning the vector images, e.g., S2300a . . . S2300n to layers, e.g., L1, L2 of the printing file 2410. The server 110 may provide a file set S2300 including the vector images as design assets to a printing generation module 2400 and, according to an input from an administrator/designer, assign vector images suitable for layer types, e.g., white layer, color layer, image layer, to the corresponding layers.

What is claimed is:

1. A method of operating a server, comprising:
generating a mask image including a first region of interest corresponding to the first nail region;
generating a plurality of first points for the first region of interest, wherein distances between the plurality of first points are determined based on a predefined nail curvature;
generating a plurality of second points for a second region of interest of a template image corresponding to the nail image;
obtaining a transformation function based on a comparison result between coordinate values of the plurality of first points and coordinate values of the plurality of second points;
obtaining a deformed image including a transformed nail region based on the transformation function and color values of the first nail region; and
obtaining a printing file based on the deformed image and controlling a production facility to generate a gel nail by performing 3D printing based on the printing file.

2. The method of claim 1, wherein generating the plurality of first points for the first region of interest comprises:
generating a plurality of corner points along an outline of the first region of interest and
generating a central point at a center of the first region of interest;
generating a plurality of outline points along the outline between the plurality of corner points; and
generating a plurality of internal points from the central point toward each of the plurality of outline points.

3. The method of claim 2, wherein generating the plurality of internal points from the central point toward each of the plurality of outline points comprises:
setting a first distance between first internal points in a first area closer to the central point based on the predefined nail curvature; and
setting a second distance, shorter than the first distance, between second internal points in a second area farther from the central point.

4. The method of claim 3, wherein a curvature of the nail corresponding to the first area is smaller than a curvature of the nail corresponding to the second area.

5. The method of claim 1, wherein obtaining the transformation function based on the comparison result of the coordinate values of the plurality of first points and the coordinate values of the plurality of second points comprises:
identifying a first reference point among the plurality of first points and identifying a second reference point among the plurality of second points corresponding to the first reference point; and
comparing coordinate values of points formed based on the first reference point among the plurality of first points with coordinate values of points formed based on the second reference point among the plurality of second points.

6. The method of claim 1, wherein obtaining a deformed image including a transformed nail region based on the transformation function and color values of the first nail region comprises:
identifying pixels of coordinate values determined by applying the transformation function to each pixel of the first nail region; and
obtaining the deformed image by assigning, to the identified pixels, color values of pixels of the first nail region.

7. The method of claim 1, wherein obtaining a deformed image including a transformed nail region based on the transformation function and color values of the first nail region comprises:
identifying color values of pixels within the nail region that are determined by applying the transformation function to the second region of interest; and
obtaining the deformed image by assigning, to pixels of the second region of interest, the identified color values of the pixels of the first nail region.

8. A method of operating a server, comprising:
obtaining a nail image including a first nail region corresponding to a nail product and a first background region;
identifying a plurality of first sub-regions within the nail region;
generating a pattern image based on identifying representative colors corresponding to the plurality of first sub-regions, the pattern image including a second nail region comprising the plurality of first sub-regions with the representative colors assigned thereto and a second background region;
generating a plurality of reference images based on the pattern image, each of the plurality of reference images including an image region corresponding to the second nail region and a remaining region including a design generated based on the second nail region;
generating a plurality of vector images for the plurality of second sub-regions; and
generating a printing file based on at least some of the plurality of vector images and controlling a production facility to generate a gel nail by performing 3D printing based on the printing file.

9. The method of claim 8, wherein the nail region includes a plurality of design elements, and attributes of the plurality of design elements of the nail region differ from attributes of the plurality of first sub-regions.

10. The method of claim 9, wherein identifying the plurality of first sub-regions within the nail region comprises:
generating a plurality of preliminary masks, each including a region of interest, by performing segmentation on the nail region;
merging a second subset of the plurality of preliminary masks based on degrees of overlap among the plurality of preliminary masks;
excluding a first subset of the plurality of preliminary masks based on sizes of the regions of interest of the plurality of preliminary masks;
obtaining a plurality of masks fewer in number than the plurality of preliminary masks based on the merging and excluding; and
